(19) United States
(12) Patent Application Publication
(10) Pub. No.: US 2015/0323479 A1
(43) Pub. Date: Nov. 12, 2015

(54) CALCULATING METHOD OF THE CORRECTION FACTOR IN FATIGUE ASSESSMENT ON THE HEATING AND COOLING TRANSIENTS OF THE POWER PLANT

(71) Applicant: KOREA HYDRO & NUCLEAR POWER CO., LTD, Gyeongju-si (KR)

(72) Inventors: Myung Hwan BOO, Daejeon (KR); Jong Jooh Kwon, Deajeon (KR); Jae Gon Lee, Daejeon (KR); Sung Gyu Jung, Yongin-si (KR); Hyun Su Kim, Yongin-si (KR); Chang Kyun Oh, Yongin-si (KR); Hee Jin Shim, Yongin-si (KR)

(21) Appl. No.: 14/622,780

(22) Filed: Feb. 13, 2015

(30) Foreign Application Priority Data
May 8, 2014 (KR) 10-2014-0054664

(51) Int. Cl. G01N 25/72

(52) U.S. Cl. CPC G01N 25/72

(57) ABSTRACT

The present invention relates to a method of calculating a fatigue usage factor, in a fatigue assessment on heating and cooling operation-transient states of a power plant, which is capable of correcting a stress intensity value under an actual operational condition by multiplying a stress intensity value, which is obtained in a design operational condition, by a stress intensity correction factor.

### CROSS-REFERENCE TO RELATED APPLICATIONS

This application claims priority from Korean Patent Application No. 10-2014-0054664, filed on May 8, 2014, in the Korean Intellectual Property Office, the disclosure of which is incorporated herein by reference in its entirety.

### BACKGROUND OF THE INVENTION

1. Field of the Invention

The present invention relates to a method of calculating a fatigue usage factor, in which a stress intensity value under an actual operational condition can be corrected by multiplying a stress intensity value, which is obtained in a design operational condition, by a stress intensity correction factor, in a fatigue assessment on heating and cooling operation-transient states of a power plant.

2. Description of the Related Art

A fatigue design of main devices and pipes of a nuclear power plant is carried out according to ASME See. III NB-3200 and NB-3600. A black curve in (a) of FIG. 1 is a heating design condition. The power plant is actually operating in an operational condition lower than a design condition, as indicated with a red curve of (a) of FIG. 1. Hence, when a fatigue assessment of a power plant is performed according to the design condition while the power plant is operating, it may bring about an excessively conservative assessment rather than an assessment performed in the actual operational condition, and cause a reduction of a fatigue lifespan.

To overcome such drawbacks, Korean Patent Publication No. 10-1083121, related to the present invention, has proposed “Apparatus and method for calculating transient-based fatigue usage factor using characteristic fatigue usage curve.” The method proposed in the document has assumed that a stress intensity cycle is generated only one time, as illustrated in (b) of FIG. 1, in an actual operational condition (or a normal operational condition) of (a) of FIG. 1. However, the stress intensity cycle may actually be generated two times or more according to an operational condition as illustrated in (c) of FIG. 1. Therefore, the method disclosed in the document results in an underestimation of fatigue affection.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

To solve the above drawbacks and other disadvantages of the prior art, an aspect of the present invention is to correctly calculate a fatigue usage factor according to each operational condition by generalizing a method of numerically calculating the number of generation of a stress intensity cycle with respect to an actual operational condition, on the basis of stress intensity correction factors α and β.

Another aspect of the present invention is to enable fast calculation of a fatigue usage factor by databasing stress intensity under operational conditions, which may be likely to be generated, on the basis of stress intensity correction factors.

In order to achieve the objects described above, there is provided a method of calculating a fatigue usage factor using stress intensity correction factors α and β, the method including: a step 1 of calculating stress intensity under an actual operational condition by multiplying stress intensity with respect to a design condition by stress intensity correction factors, which consider a characteristic of the actual operational condition, as expressed by Equation (4);

SINT_{Actual}=α×β×SINT_{Design} (4)

a step 2 of deriving a transient state condition showing the greatest range from the calculated stress intensity; a step 3 of calculating alternating stress intensity Sₐₗₜ; a step 4 of calculating an allowable repetition number by substituting the alternating stress intensity into an alternating stress intensity-allowable cycle diagram relevant to a specific material provided by ASME Sec. III; and a step 5 of calculating a fatigue usage factor by dividing the number of actual operation cycles by an allowable number of cycles.

### EFFECT OF THE INVENTION

The present invention can provide an advantageous effect of correctly calculating a fatigue usage factor according to each operational condition in a manner of generalizing a method of numerically calculating the number of generation of a stress intensity cycle with respect to an actual operational condition by applying stress intensity correction factors α and β.

The present invention can also provide another effect of fast calculating a fatigue usage factor in a manner of databasing stress intensity with respect to occurrable operational conditions on the basis of stress intensity correction factors.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is a view illustrating results of comparing a design heating condition and actual heating condition with corresponding stress intensity time histories; and

FIG. 2 is a view illustrating various heating patterns occurrable at design and actual operations.

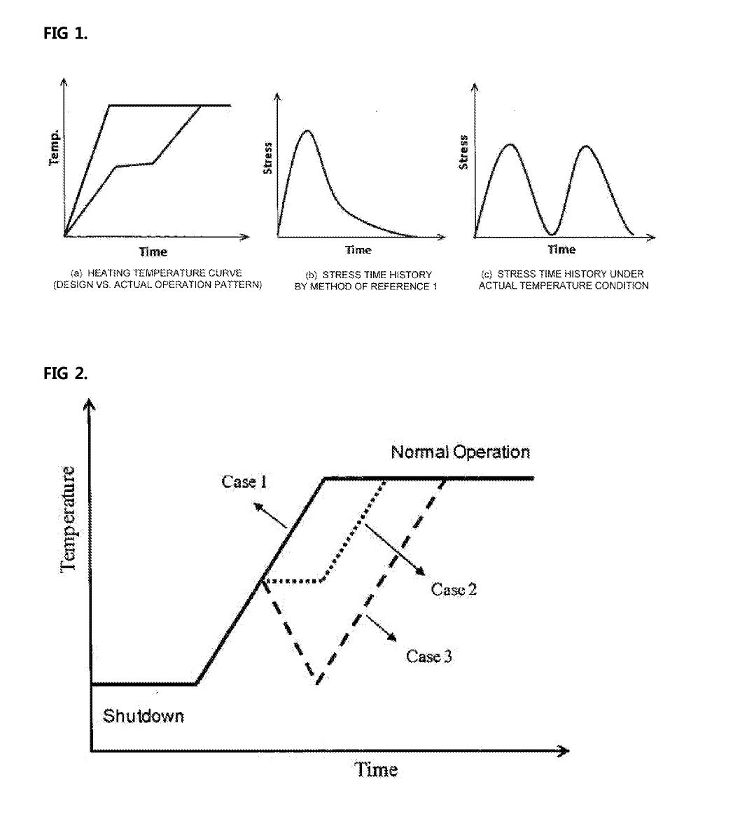

### DETAILED DESCRIPTION OF THE EXEMPLARY EMBODIMENTS

Certain exemplary embodiments of the present invention will now be described in greater detail with reference to the accompanying drawings.

FIG. 2 illustrates various heating patterns which are likely to be generated under design and actual operation conditions. Case 1 shows heating under a design condition. Case 2 shows heating-specific temperature maintenance in the course-reheating and Case 3 shows heating-complete cooling-reheating, both under an actual operational condition.

A heating/cooling rate under the design condition is 100° F./hr, and a heating/cooling rate under the actual operational condition is 50° F./hr.

Referring to FIG. 2, for the heating-temperature maintenance-reheating condition (Case 2), an additional stress cycle is generated one time as compared with the design condition (Case 1). For the heat-complete cooling-reheating condition (Case 3), the additional stress cycle is generated two times as compared with the design condition (Case 1).

Therefore, in view of an affection with respect to the additionally generated stress cycle, correction factors α and S may be obtained in a manner of comparing a fatigue assessment result of the design condition (Case 1) with a fatigue assessment result of the operational conditions (Cases 2 and 3), and the number of times that the stress intensity cycle is generated may be generalized using the obtained correction factors α and S.

That is, a step of generalizing the number of generation of the stress intensity cycle by using the correction factors α and β obtained through the comparison between the fatigue assessment result of the design condition (Case 1) and the fatigue assessment result of the operational conditions (Cases 2 and 3) is included.

Hereinafter, description will be given of a calculation of a stress intensity correction factor α according to a transient state type.

To calculate the stress intensity correction factor α according to the transient state type, a load combination with an arbitrary transient state A is assumed. A transient state load combination of the design condition (Case 1) of FIG. 2 and the heating-complete cooling-reheating condition (Case 3) is shown in Table 1. Table 1 shows the transient state combination under a heating condition.

TABLE 1

| | | | |
|---|---|---|---|
| Transient state | Transient state | Sₐₗₜ (Alternating | |
| type | combination | stress) | N |

| | | | | |
|---|---|---|---|---|
| 1 | Case 1 | A | (S₁ + S_{A})/2 | 1 |
| 2 | Case 2 | A | (S₁ + S_{A})/2 | 1 |
| | Case 3 | Case 3 | (S₃ + S₃)/2 | 1 |

When the transient state type 2 (Case 3) is generated, stress intensity is different from that of the transient state type 1 (Case 1). Therefore, an equivalent allowable number of cycles N_{eq} for the transient state type 2 is calculated using Equation (1).

Here, N1 and N3 are calculated by substituting a cycle for each alternating stress intensity of Table 1 into an alternating stress intensity-allowable cycle diagram relevant to a corresponding material provided by ASME Sec. III.

$${N}_{eq} = \frac{1}{\frac{1}{{N}_{1}} + \frac{1}{{N}_{3}}} = \frac{1}{\frac{1}{SN {\text{\textbar}}_{{S}_{alt} = \frac{{S}_{1} + {S}_{A}}{2}}} + \frac{1}{SN {\text{\textbar}}_{{S}_{alt} = \frac{{S}_{3} + {S}_{3}}{2}}}} \qquad ( 1 )$$

Here, equivalent stress intensity S_{eq} is calculated by substituting the equivalent allowable number of cycles N_{eq}, calculated by Equation (1), into the alternating stress intensity-allowable cycle diagram for the corresponding material provided by ASME Sec. III.

Finally, the stress intensity correction factor α according to the transient state type is calculated by Equation (2).

$$α \frac{{S}_{1}}{2} + \frac{{S}_{A}}{2} = {S}_{eq} , α = \frac{( {S}_{eq} + \frac{{S}_{A}}{2} ) \times 2}{{S}_{1}} \qquad ( 2 )$$

(α: correction factor according to transient state type)

Hereinafter, a calculation of a stress intensity correction factor β according to a heating/cooling rate will be described.

The change in the heating/cooling rate derives the change in the stress intensity. Hence, the stress intensity should be corrected by calculating the stress intensity correction factor β according to each heating/cooling rate. The stress intensity correction factor β is calculated, as expressed by Equation (3), as a rate between stress intensity according to a specific heating/cooling rate and design stress intensity. Here, the specific heating/cooling rate may be calculated under the assumption that an actual heating/cooling rate can be changeable up to 10% to 120% of a value under the design condition.

$$β = \frac{{S}_{( 0.1 \sim 1.2 ) \times design}}{{S}_{design}} \qquad ( 3 )$$

S_{Actual} denotes stress intensity in the actual transient state, and S_{Design} denotes stress intensity in the design transient state.

Hereinafter, description will be given of a method of calculating a fatigue usage factor using stress intensity correction factors α and β.

The stress intensity correction factors α and β are used for calculation of the fatigue usage factor, as follows.

Step 1: stress intensity is calculated by Equation (4) by considering a design operational condition.

SINT_{Actual}=α×β×SINT_{Design} (4)

Step 2: a transient state condition which shows the largest range is derived from the calculated stress intensity.

Step 3: an alternating stress intensity Sₐₗₜ is calculated.

Step 4: an allowable number of cycles is calculated by substituting the alternating stress intensity Salt into an alternating stress intensity-allowable cycle diagram relevant to a corresponding material provided by ASME Sec. III.

Step 5: a fatigue usage factor is calculated by dividing the number of actual operations by the allowable number of cycle.

The present invention can apply a method, in which a stress intensity value obtained in an actual operational condition can be corrected by multiplying a stress intensity value, calculated under a design operational condition, by stress intensity correction factors, to a calculation of a fatigue usage factor. This may allow for more accurate fatigue assessment on heating and cooling operation-transient states of a power plant.

The present invention is not limited by those preferred embodiments, and those skilled in the art will appreciate that various modifications, additions and substitutions are possible, without departing from essential characteristics of the disclosure.

### DESCRIPTION OF REFERENCE NUMERALS

UF: fatigue usage factor
N: allowable number of cycles
N_{eq}: equivalent allowable number of cycles
n: the number of stress cycles
S: stress intensity
S_{Actual}: stress intensity in an actual operation-transient state
S_{Design}: stress intensity in a design-transient state
Sₐₗₜ: alternating stress intensity
S_{eq}: equivalent stress intensity
α: stress correction factor on the basis of a transient pattern
β: stress correction factor on the basis of a heating/cooling rate
S₁, S_{A}, S₃: stress intensity on the basis of a given transient state

What is claimed is:

1. A method for calculating a fatigue usage factor using stress correction factors according to a transient state type, the method comprising:
calculating stress intensity using Equation (4) by considering an actual operational condition;
SINT_{Actual}=α×β×SINT_{Design} (4)
deriving a transient state condition showing the largest range from the calculated stress intensity;
calculating alternating stress intensity (Sₐₗₜ);
calculating an allowable repetition number by substituting the alternating stress intensity (Sₐₗₜ) into a fatigue characteristic curve of a specific material; and
calculating a fatigue usage factor by dividing the number of actual operations by the allowable repetition number.

2. The method of claim 1, wherein a stress correction factor (α) according to the transient state type is calculated by Equation (2).
$$α \frac{{S}_{1}}{2} + \frac{{S}_{A}}{2} = {S}_{eq} , α = \frac{( {S}_{eq} + \frac{{S}_{A}}{2} ) \times 2}{{S}_{1}} \qquad ( 2 )$$

3. The method of claim 1, wherein a stress correction factor (β) is calculated by Equation (3).
$$β = \frac{{S}_{( 0.1 \sim 1.2 ) \times design}}{{S}_{design}} \qquad ( 3 )$$
